(19) United States
(12) Patent Application Publication
(10) Pub. No.: US 2026/0056126 A1
(43) Pub. Date: Feb. 26, 2026

(54) SYSTEMS AND METHOD TO CALIBRATE AND MEASURE FLUORESCENCE

(71) Applicant: DATACOLOR INC., LAWRENCEVILLE, NJ (US)

(72) Inventor: Zhiling Xu, Princeton Junction, NJ (US)

(73) Assignee: DATACOLOR INC., LAWRENCEVILLE, NJ (US)

(21) Appl. No.: 18/812,104

(22) Filed: Aug. 22, 2024

(51) Int. Cl. G01N 21/64; G01J 3/28; G01J 3/44; G01J 3/50

(52) U.S. Cl. CPC G01N 21/645; G01J 3/4406; G01J 3/501; G01J 2003/2879

(57) ABSTRACT

A method and a system have been developed to calibrate the total spectral radiance factor (TSRF) obtained from different instruments. A broad-band light source covering the whole visible range as well as the fluorescence excitation wavelengths is used to measure the TSRF, and one or more narrow-band light sources outside of the fluorescent band is used to measure fluorescent spectral radiance factor (FSRF) separately. After that, the TSRF is adjusted by the FSRF, and a calibrated TSRF can be obtained. This can be applied to characterize Optical Brightening Agents (OBAs) as well as other fluorescent materials without requiring any moving part of the instrument to do the calibration.

### FIELD OF THE INVENTION

The systems, methods, devices and processes described herein are directed to inter-instrument compensation of total spectral radiance factor measurements made by color or light measurement instruments.

### BACKGROUND OF THE INVENTION

Fluorescence plays an important role in many color samples. For example, Optical Brightening Agents (OBAs) are added in fabric, paper or other materials to enhance the “whitening” effect. Fluorescent material that emits other wavelength lights are also added to different materials to provide brighter and more vivid colors.

In currently available color measurement devices, the total spectral radiance factor (TSRF) is usually measured in order to characterize fluorescent material. These measurements are heavily dependent on the spectral power distribution of the light source used to illuminate the sample. Therefore, the result is not universal and hardly comparable among different instruments.

There exists in the art approaches to compensate for these drawbacks. For example, commonly owned U.S. Pat. No. 10,883,878 to Xu et. al., teaches a method to measure fluorescence with multiple narrow-band light sources. However, the described approach requires complex light source arrangements and the proper calibration of measurement sensors. Additionally, the measurement process described in this patent takes a novel approach to an industry problem and thus is not easy to be adopted by others.

Additionally, U.S. Pat. No. 11,287,376 to Xu et. al., teaches a method to calibrate OBA measurements in order to obtain standardized and comparable results. This patent teaches the use of a UV excluded light source and a UV light source. However, the use of UV excluded light source limits the application wavelength range. If the excitation wavelength is extended into the blue and/or other visible colors, it is hard to design a light source to exclude those visible colors while still maintaining the capability to measure reflectance or transmittance of those colors.

Therefore, what is needed in the art is a method to calibrate fluorescence measurement such that the results obtained from different instruments are comparable. In this disclosure, we will discuss a novel way of calibrating TSRF measurement of different instruments and make the measurement result be comparable.

### SUMMARY OF THE INVENTION

A method and a system have been developed to calibrate the total spectral radiance factor (TSRF) obtained from different instruments. A broad-band light source covering the whole visible range as well as the fluorescence excitation wavelengths is used to measure the TSRF, and one or more narrow-band light sources outside of the fluorescent band is used to measure fluorescent spectral radiance factor (FSRF) separately. After that, the TSRF is adjusted by the FSRF, and a calibrated TSRF can be obtained. This can be applied to characterize Optical Brightening Agents (OBAs) as well as other fluorescent materials without requiring any moving part of the instrument to do the calibration.

A color measurement system for obtaining the total spectral radiance factor (TSRF) of a sample under analysis, the system comprising: a color measurement device comprising: a first illuminator, a second illuminator, and a processor configured by code executing therein to obtain a first measurement of the sample under a first illumination generated by the first illuminator; obtain a second measurement of the sample under a second illumination generated by the second illuminator; obtaining a lamp profile of the first illuminator from one of a plurality of data storage devices accessible to the processor; obtaining a calibration factor, wherein the calibration factor is generated using measurements obtained from at least the first and second illuminator; calculating a compensated TSRF value for the sample using the first measurement, the second measurement, the lamp profile, and the calibration factor; outputting the compensated TSRF value for the sample. In a further implementation, the compensated TSRF value is calculated according to: B₁(λ)=B2(λ)−βf(λ)/S₀(λ), where, B₁(λ) is the compensated TSRF value of the calibration standard, B₂(λ) is the first measurement made under the first illuminator, f(λ) is the second measurement made under the second illuminator, S₀(λ) is the lamp profile of the first illuminator and β is the calibration factor.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 details one or more components of the TSRF measurement compensation system as described herein.

FIG. 2 details modules that configure the one or more processors of the measurement systems described herein.

FIG. 3 is a flow diagram detailing the TSRF calibration process.

FIG. 4 is a flow diagram detailing aspects of the TSRF calibration process.

### DETAILED DESCRIPTION OF CERTAIN EMBODIMENTS OF THE INVENTION

In the color measurement industry, fluorescent material is often characterized through measuring the total spectral radiance factor (TSRF) of a sample. However, even for the same model of instrument produced by the same manufacturer, the spectral power distribution of the illumination lamp can be different from unit to unit, and thus the measurement result may be different and not comparable. One example of this issue is the measurement of color samples that have Optical Brightening Agents (OBAs) added. Here, if one instrument has higher UV content in the spectral power distribution of its illumination lamp, it will excite more fluorescence in the visible light range and result in larger value of TSRF, and the whiteness index (WI) calculated from the TSRF will also be larger. Therefore, the TSRF or WI of the same sample measured with two different instruments are not comparable.

The traditional way to solve this issue is to adjust the UV content of the illumination light using a tunable UV-cutoff filter. An alternative method without using any mechanically moving UV-cutoff filters is taught in patent U.S. patent Ser. No. 11/287,376, granted to Xu et al. However, the methods taught therein are directed to UV-excited fluorescence measurements.

In one or more implementations or embodiments described herein, a color measurement device, or color measurement system is provided that is configured to be used to measure and/or calibrate total spectral radiance factor measurements. In other implementations or embodiments described herein, a method and a system are provided to calibrate the total spectral radiance factor (TSRF) obtained from different instruments. In a particular implementation or embodiment, a broad-band light source covering the whole visible range as well as the fluorescence excitation wavelengths is used to measure the TSRF, and one or more narrow-band light sources outside of the fluorescent band are used to measure fluorescent spectral radiance factor (FSRF) separately. After that, the TSRF is adjusted by the FSRF, and a calibrated TSRF is obtained.

It will be appreciated that the foregoing devices, systems, methods and processes represent an improvement and advancement over existing techniques. For example, the calibrated measurements obtained according to the forgoing disclosure can be applied to characterize Optical Brightening Agents (OBAs) as well as other fluorescent materials without requiring any moving part of the instrument to do the calibration. Thus, the present approach allows for a longer life of the measurement device, as it does not require complex and expensive moving parts to obtain TSRF measurements.

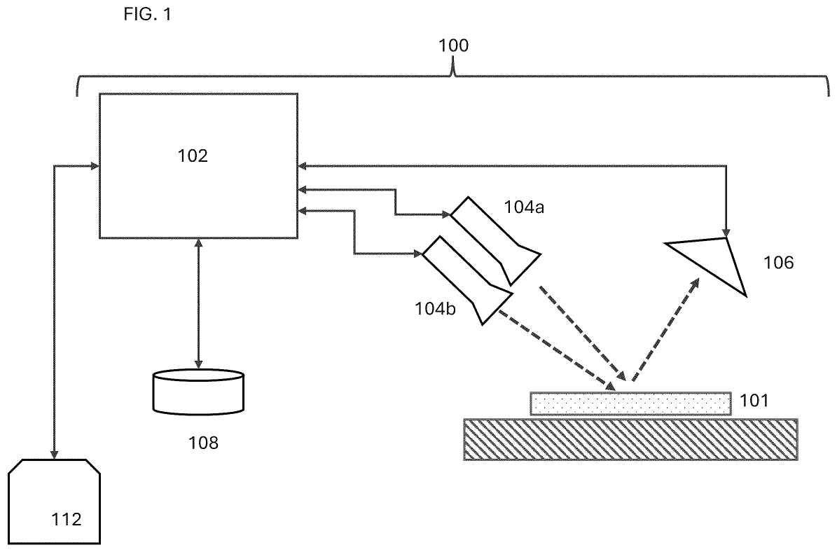

Turning now to FIG. 1, an illustration of the elements of a color measurement device according to the subject matter described herein is provided. As shown, the measurement device includes illuminators 104, one or more light measurement devices or sensors 106, one or more processors 102, and one or more output devices.

With continued reference to FIG. 1, at least two (2) illuminators 104a and 104b are configured to emit light and cause such emitted light to illuminate the sample 101. In one instance, each of illuminators 104a and 104b are single lighting element devices. However, in alternative implementations, illuminators 104a and 104b are a collection of separate lighting devices that are configurable to produce a light with certain wavelength bands. For instance, the illuminator 104 can, in one implementation, be one or more discrete light emitting elements, such as LEDs or OLEDs; fluorescent, halogen, xenon, neon, fluorescent, mercury, metal halide, HPS, or incandescent lamps; or other commonly known or understood lighting sources. In one arrangement, the illuminator 104 is one or more wide-band LEDs.

In one particular implementation, one of the illuminators 104a is a xenon illuminator. In a further implementation, one of the illuminators 104b is one or more narrow-band LEDs. In one particular implementation, the illuminators 104b is a UV LED. In another arrangement, one of the illuminators 104b is a broad band light source configured with one or more UV band-pass filters positioned between the illuminator 104b and the sample 101.

In one or more implementations, the illuminators 104a and 104b are light sources incorporated into a spectrophotometer, such as Datacolor's DC800. In another implementations, the illuminators 104a and 104b are incorporated into Datacolor's 45G product.

With continued reference to FIG. 1, at least illuminators 104a and 104b are configured to emit light and provide illumination to the sample 101. For instance, the illuminators 104a and 104b are configured to direct light towards a sample 101, which is then transmitted or reflected to the light measurement sensor 106.

In one or more implementations, the illuminators 104a and 104b include a lens, filter, screen, enclosure, or other elements (not shown) that are utilized in combination with the light source of the illuminators 104a and 104b to direct a beam of illumination, at a given wavelength, to the light measurement sensor 106.

In a particular implementation, the illuminators 104a and 104b are operable or configurable by an internal processor or other control circuit. Alternatively, the illuminators 104a and 104b are operable or configurable by a remote processor or control device having one or more linkages or connections to the illuminators 104. As shown in FIG. 1, illuminators 104a and 104b are directly connected to a processor or computer 102.

Continuing with FIG. 1, light generated by the illuminators 104a and 104b are captured or measured by one or more measurement devices, such as the light measurement sensor 106. It will be understood that the light captured is light that has been reflected off a sample (such as sample 101) or through a transmissive sample.

Here, the light measurement sensor 106 can be a color sensor or image capture device. For example, the light measurement sensor 106 is a scientific CMOS (Complementary Metal Oxide Semiconductor), CCD (charge coupled device), colorimeter, spectrometer, spectrophotometer, photodiode array, or other light sensing device and any associated hardware, firmware and software necessary for the operation thereof. In one particular implementation, the light measurement sensor 106 is a multi-channel spectral sensor or similar device. In one or more implementations, the light measurement sensor(s) 106 described herein, have multiple optical, NIR or other wavelength channels to evaluate a given wavelength range. However, other potential sensor configurations and wavelength channels having varying numbers of sensor channels and operational characteristics are understood and appreciated.

In a particular implementation, light measurement sensor 106 is the same sensor present in Datacolor's DC800, DC1000 or 46G measurement devices (the technical specifications of which are herein incorporated by reference in its entirety).

In a further arrangement, the light measurement sensor 106 is configured in a d/8 or 45/0 measurement geometry with the illuminator(s) 104a and 104b.

In one or more configurations, the light measurement sensor 106 is configured to generate an output signal upon light striking a light sensing portion thereof. By way of non-limiting example, the light measurement sensor 106 is configured to output signals in response to light that has been emitted by illuminator(s) 104a and 104b.

For instance, light measurement sensor 106 is configured to generate a digital or analog signal that corresponds to the wavelength or wavelengths of light that are captured or received by the light measurement sensor 106. In one or more configurations, the light measurement sensor 106 is configured to output spectral information, RGB information, or another form of multi-wavelength data representative of light reflected off a sample 101.

As shown in FIG. 1, the light measurement sensor 106 is configured to transmit one or more measurements to a processing platform, such as processor 102. In one or more configurations, at least one light measurement sensor 106 is directly connected to processor 102. However, in one or more implementations, one or more light measurement sensors 106 (where there are multiple such sensors) are equipped or configured with network interfaces or protocols usable to communicate over a network, such as the internet. In this configuration, measurements made by light measurement sensors 106 are sent to a remote processor for evaluation and analysis.

Alternatively, at least one light measurement sensor 106 is connected to one or more computers or processors, such as processor 102, using standard interfaces such as USB, FIREWIRE, Wi-Fi, Bluetooth, and other wired or wireless communication technologies suitable for the transmission measurement data.

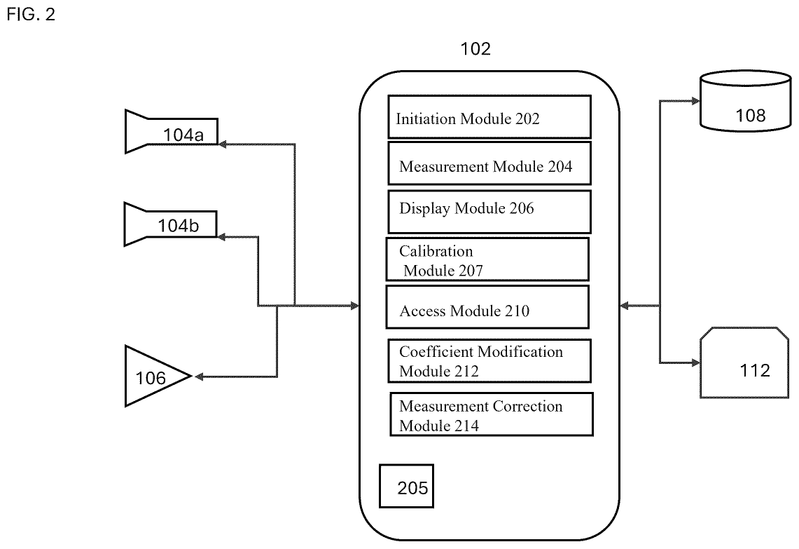

The output signals generated by the light measurement sensor 106 are transmitted to one or more processor(s) 102 for evaluation as a function of one or more hardware or software modules. As used herein, the term “module” refers, generally, to one or more discrete components that contribute to the effectiveness of the presently described systems, methods and approaches. Modules can include software elements, including but not limited to functions, algorithms, classes and the like. In one arrangement, the software modules are stored as software in memory 205 of processor 102, as shown in FIG. 2.

Modules can, in some implementations, include discrete or specific hardware elements. In one implementation, processor 102 is located within the same device or enclosure as the light measurement sensor 106. For example, both the processor 102 and light measurement sensor 106 are components of a spectrophotometer. However, in another implementation, processor 102 is remote or separate from the light measurement sensor 106 and communicates over one or more communication linkages.

In one configuration, processor 102 is configured through one or more software modules to generate, calculate, process, output, or otherwise manipulate the output signals generated by the light measurement sensor 106.

In one implementation, processor 102 is a commercially available computing device. For example, processor 102 may be a collection of computers, servers, processors, cloud-based computing elements, micro-computing elements, computer-on-chip(s), home entertainment consoles, media players, set-top boxes, prototyping devices or “hobby” computing elements.

Furthermore, processor 102 can comprise a single processor, multiple discrete processors, a multi-core processor, or other type of processor(s) known to those of skill in the art, depending on the particular embodiment. In a particular example, processor 102 executes software code on the hardware of a custom or commercially available cellphone, smartphone, notebook, workstation, or desktop computer configured to receive data or measurements captured by one or more light measurement sensors 106 either directly, or through a communication linkage.

Processor 102 is configured to execute a commercially available or custom operating system, e.g., Microsoft WINDOWS, Apple OSX, UNIX or Linux-based operating system in order to carry out instructions or code. In a particular implementation, processor 102 is a computer, workstation, thin client or portable computing device such as an Apple iPad/iPhone® or Android® device or other commercially available mobile electronic device configured to receive and output data to or from database 108 and the light measurement sensor 106.

In one or more implementations, processor 102 is further configured to access various peripheral devices and network interfaces. For instance, processor 102 is configured to communicate over the internet with one or more remote servers, computers, peripherals or other hardware using standard or custom communication protocols and settings (e.g., TCP/IP, etc.).

Processor 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of processor 102 provides for the storage of application program and data files. One or more memories provide program code that processor 102 reads and executes upon receipt of a start, or initiation signal.

The computer memories may also comprise secondary computer memory, such as magnetic or optical disk drives or flash memory, that provide long term storage of data in a manner similar to a persistent memory device. In one or more embodiments, the memory of processor 102 provides for storage of an application program and data files when needed.

As shown in FIG. 1, processor 102 is configured to store data either locally in one or more memory devices. Alternatively, processor 102 is configured to store data, such as measurement data or processing results, in a local or remotely accessible database 108. The physical structure of database 108 may be embodied as solid-state memory (e.g., ROM), hard disk drive systems, RAID, disk arrays, storage area networks (“SAN”), network attached storage (“NAS”) and/or any other suitable system for storing computer data. In addition, database 108 may comprise caches, including database caches and/or web caches. Programmatically, database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. Database 108 includes the necessary hardware and software to enable processor 102 to retrieve and store data within database 108.

In one implementation, each element provided in FIG. 1 is configured to communicate with one another through one or more direct connections, such as through a common bus. For example, when each of the components are contained within the same form-factor (such as a spectrophotometer), each component is connected to the processor 102, and optionally one another, through one or more direct electrical linkages. Alternatively, each element is configured to communicate with the others through network connections or interfaces, such as a local area network LAN or data cable connection. In an alternative implementation, the light measurement sensor 106, processor 102, and database 108 are each connected to a network 110, such as the internet, and are configured to communicate and exchange data using commonly known and understood communication protocols.

In one arrangement, processor 102 communicates with a local or remote display device 112 to transmit, displaying or exchange data. In one arrangement, the display device 112 and processor 102 are incorporated into a single form factor, such as a spectrometer, that includes an integrated display device. In an alternative configuration, the display device 112 is a remote computing platform such as a smartphone or computer that is configured with software to receive data generated and accessed by processor 102. For example, processor 102 is configured to send and receive data and instructions from a processor(s) of a remote display device 112.

This remote display device 112 includes one or more display devices configured to display data obtained from processor 102. Furthermore, display device 112 is also configured to send instructions to processor 102. For example, where processor 102 and the display device are wirelessly linked using a wireless protocol, instructions can be entered into display device 112 that are executed by the processor. Display device 112 includes one or more associated input devices and/or hardware (not shown) that allow a user to access information, and to send commands and/or instructions to processor 102. In one or more implementations, the display device 112 can include a screen, monitor, display, LED, LCD or OLED panel, augmented or virtual reality interface or an electronic ink-based display device.

It will be understood and appreciated that the components described here can be used to measure the light properties of a sample 101. In one or more implementations, sample 101 can be any type or form of physical article having color or spectral properties in need of analysis. For ease of reference and discussion, the foregoing descriptions the sample 101 refers to an article or material that has stable and uniform color and can be evaluated by currently available spectrophotometers.

In one or more further or alternative implementations, sample 101 includes optical brightening agents or other materials that cause the sample 101 to have fluorescence properties.

Those possessing an ordinary level of skill in the requisite art will appreciate that additional features, such as power supplies, power sources, power management circuitry, control interfaces, relays, adaptors, and/or other elements used to supply power and interconnect electronic components and control activations are appreciated and understood to be incorporated.

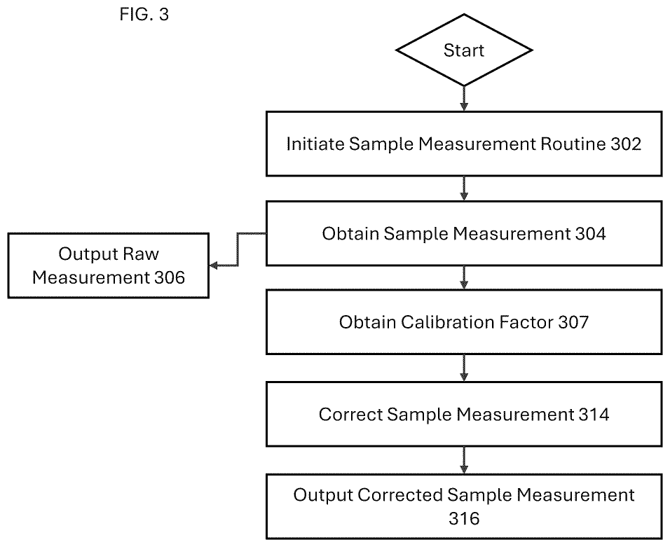

Turning now to FIGS. 2 and 3, a system and process for obtaining accurate color measurements is described. However, by way of overview, it will be appreciated by those possessing an ordinary level of skill in the requisite art that TSRF is defined as the ratio of spectral radiance illuminated and observed under the same conditions at wavelength λ of an observed fluorescent sample and of a completely diffuse, non-fluorescent, perfectly reflecting surface. Alternatively, TSRF may also be defined as the ratio of the flux intensity at wavelength λ returned from the fluorescent sample and from the completely diffuse reflecting surface in the same solid angle of the same direction, when illuminated under the same conditions. Thus, TSRF may be expressed as:

$$B ( λ ) = S ( λ ) / {S}_{0} ( λ ) \qquad ( 1 )$$

where S(λ) is the intensity at wavelength λ of the radiant light from the fluorescent sample, and S0(λ) is the intensity at wavelength λ of the radiant light reflected from the complete diffuse reflection surface.

In general, S(λ) includes two parts as indicated by equation (2):

$$S ( λ ) = R ( λ ) {S}_{0} ( λ ) + k f ( λ ) \qquad ( 2 )$$

where R(λ) is the reflectance of the sample, and f(λ) is the fluorescent profile of the sample. From equations (1) and (2), we know that

$$B ( λ ) = R ( λ ) + k f ( λ ) / {S}_{0} ( λ ) \qquad ( 3 )$$

For the sake of discussion, if one wants to compare the B(λ) result of the same sample measured by two different instruments, it can be assumed that everything is the same for the two instruments, except that one instrument has more fluorescent excitation light content than the other, and thus will excite stronger fluorescent signal. It can also be assumed that the fluorescent excitation light is not in the wavelength range of B(λ) covered in equation (3). For example, the excitation wavelength of an OBA sample is in the UV range, but the TSRF discussed in equation (3) is in the visible wavelength range.

Given the above assumptions, the TSRF results of the same sample measured with two instruments differ only in the fluorescence part, i.e.

$${B}_{1} ( λ ) = R ( λ ) + {k}_{1} f ( λ ) / {S}_{1} ( λ ) \qquad ( 4 )$$

$${B}_{2} ( λ ) = R ( λ ) + {k}_{2} f ( λ ) / {S}_{2} ( λ ) \qquad ( 5 )$$

where k₁ and k₂ are instrument dependent coefficients, S1(λ) and S2(λ) are the illumination profiles of the two instruments. Since we assume that S1(λ) and S2(λ) are quite similar, just differ in magnitude, we can use S0(λ) to replace them, and the magnitude difference can be digested in coefficients k₁ and k₂. Considering equations (4) and (5), we can get

$${B}_{1} ( λ ) = {B}_{2} ( λ ) - ( {k}_{2} - {k}_{1} ) f ( λ ) / {S}_{0} ( λ ) \qquad ( 6 )$$

Let k₂−k₁=β, then equation (6) can be written as

$${B}_{1} ( λ ) = {B}_{2} ( λ ) - β f ( λ ) / {S}_{0} ( λ ) \qquad ( 7 )$$

Thus, it will be appreciated that the fluorescent profile of the sample can be used to adjust the TSRF of the second instrument in order to match the TSRF result of the first instrument.

Thus, a process as shown in FIGS. 2 and 3, is provided to calibrate a measurement device, and to ensure that measurements made by such a device are accurate.

In one particular implementation, a color measurement device (such as device 100) is configured to obtain a measurement of a sample, such as sample 101. Here, the color measurement device 100 is configured with at least two (2) illuminators. Here, one of the illuminators is a broadband illumination light source (104a), such as a common Xenon lamp. In a further implementation, the color measurement device 100 also includes a second illuminator 104b, such as a narrow-band fluorescence excitation light source, such as a 365 nm UV LED.

In one or more implementations, the color measurement device 100 is a spectrophotometer. For ease of explanation, this spectrophotometer is referred to as the test instrument. The test instrument can have a d/8 measurement geometry, such as Datacolor's DC800 instrument, or a 45/0 measurement geometry, such as Datacolor's 45G instrument, or other commonly used geometries.

In the following implementation, the sample 101 is a white fabric with OBA added. However, those possessing an ordinary level of skill in the requisite art will appreciate that alternative samples can be evaluated using the described devices, processes, systems and methods.

Turning now to FIGS. 2 and 3, the processor 102 is configured by one or more modules to initiate or start a measurement routine for a sample under analysis. In one particular implementation, the processor 102 is configured by one or more initiation module(s) 202 executing as code in the processor. As shown in step 302 the processor sends a flag, data packet, or other signal to the illuminator 104a causing that illuminator 104a to activate. In response to this activation light is directed towards the sample 101 and either reflected or transmitted through the sample 101 and is incident upon a measurement portion of the light measurement sensor 106. In one particular implementation, the illuminator 104a is a Xenon lamp. While the xenon lamp is activated, the UV LED is deactivated.

As shown in step 304 the processor 102 is configured with a measurement module 204 executing this code in the processor 102 that configures the processor 102 to interpret signal generated by the light measurement sensor 106 in response to light incident upon it. As part of step 304, the processor 102 is configured by the measurement module 204 to generate a TSRF value for the sample 101. For example, one or more submodules of the measurement module 204 are configured to receive raw data from the light measurement sensor 106 and convert that measurement data into the TSRF value. In one arrangement, the sub-modules of the measurement module 204 receive raw data in the form of electrical signals, digital data, analog data, a data file, color values (such as but not limited to tri-stimulus, rgb, etc.), sensor counts or other data or signals that are generated by light measurement sensor 106.

The processor 102 is further configured by a display module 206 to generate on the remote display device 112 the measured TSRF value. For example, as shown in step 306, the uncalibrated TSRF value is generated as displayed on a screen of the remote 112 device. Additionally, or alternatively, the uncalibrated TSRF value is stored in the database 108 for further reference.

However, it will be appreciated that without calibration, the TSRF measured with the in steps 302-304 for a given measurement device 100 will be different from the TSRF measured of the same sample 101 with a reference instrument. This holds true even if a given measurement device 100 and the test instrument have the same components. Therefore, to obtain a more accurate TSRF measurement result from the measurement device 100, the value obtained in steps 302-304 must be adjusted by a calibration factor or by calibrating the test instrument.

In one or more implementations, the processor 102 is configured by a calibration module 207 to calibrate or adjust the measurement made in steps 302-304. In one arrangement, the calibration module 207 configures the processor 102 to access a calibration factor from one or more data storage devices, such as database 108. In another configuration, the processor 102 is configured by the calibration module 207 to carry out a calibration process to generate a calibration factor for use on the measurements obtained in step 304. In particular, the processor 102 is configured by the calibration module 207 to carry out a calibration process to calibrate the measurement device such that the generated TSRF values are uniform across the same make or model of measurement devices.

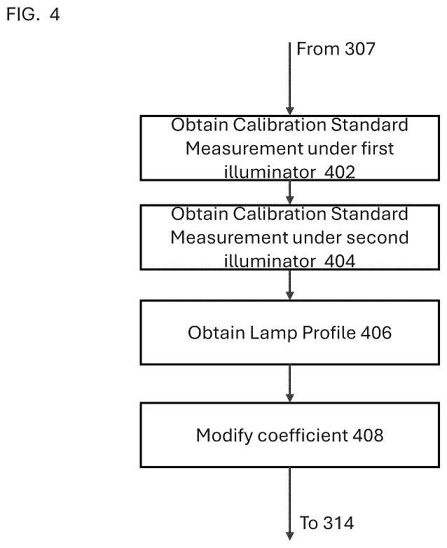

Turning now to FIG. 4, to calibrate the test instrument, the processor 102 is configured by a calibration module 208 to obtain a calibration measurement. As shown in step 402, the processor 102 is configured to obtain a TSRF measurement of an OBA standard 103 with known whiteness index, herein referred to as WI1. In one implementation of step 402, the processor 102 is configured by the measurement module 204 to activate illuminator 104a, for example, a xenon lamp, and obtain the corresponding measurement values from the light measurement device 106. Next, the processor 102 is configured to store the obtained measurement value of this known sample, which will hereinafter be referred to as B₂.

Next, the calibration module 207 further configures the processor 102 to obtain a measurement of the known calibration standard 103 using the second illuminator 104b. For example, as shown in step 404, the processor 102 is configured by the measurement module 202 to activate a narrow-band UV LED to illuminator the known calibration standard 103. The processor 102 obtains measurement values based on light reflected off of (or transmitted through) the known calibration standard 103. The processor 102 is configured to store this output value as the fluorescent profile f(λ) of the OBA standard 103. In one or more implementations, the processor 102 configured by the calibration measurement module 208 is configured to convert, calculate, or otherwise generate the fluorescent profile f(λ) of the OBA standard 103 based on the obtained measurements.

Next, as shown in step 406, the processor 102 is configured by an access module 310, to access a lamp profile for the first illuminator 104a. For example, the processor 102 is configured to access from a memory, such as the database 108, a lamp profile. In one implementation, the processor 102 is configured to automatically access the lamp profile of the illuminator 104a. Here, the processor 102 is configured to communicate with the illuminator 104a and exchange data, such as a lamp profile. Alternatively, the processor 102 is configured to access the lamp profile from a look-up table or other data structure that stores one or more lamp profiles. In yet a further implementation, a user can select a particular lamp profile for further use. In the foregoing example, the processor 102 is configured to select a typical Xenon lamp profile and store that data for further use as S0(λ).

The processor 102 is configured by a coefficient modification module 212 to adjust the coefficient β for equation 7 to be true. For example, the coefficient modification module 212 configures the one or more processors to engage in an optimization process. Here the optimization process optimizes coefficient β by adjusting its value in equation 7. As shown in step 408, the processor 102 is suitably configured such that with access to the measured values of B₂, f(λ) and S0(λ), it can adjust the coefficient β to obtain a TSRF result B₁ such that the calculated whiteness index from B₁ equals to the known whiteness index of the OBA standard (calibration standard 103) value WI1. Here, it should be appreciated that a whiteness index value can be calculated from a TSRF value. Therefore, as part of the coefficient modification step 408, the processor 102 is configured to calculate the TSRF value for the OBA standard so that the calculated whiteness index from the TSRF value matches the known value WI1. This calculated TSRF value is B₁, and the coefficient β generated by the processor 102 is such that equation 7 is true.

Thus, it will be appreciated that one way is to obtain B1 from equation 7, and match B1 with the known TSRF of the calibration standard. Alternatively, B₁ can be obtained from equation 7. Using these values the Whiteness Index using B₁ can be calculated. Next, the processor 102 is configured to let the calculated Whiteness Index match the known WI1 of the calibration standard. In many cases, the reference TSRF (measured with a reference instrument) of the calibration standard is unknown, but the Whiteness Index of the calibration standard is known, thus alternative approaches can be selected based on available information at the time.

In one or more alternative approaches of the calibration process described, instead of matching the whiteness index of the same calibration standard 103 obtained by measurement using the test instrument and the reference instrument, the TSRF can be matched directly. However, in order to match the TSRF values directly, the TSRF value for the calibration standard 103, as obtained by a reference instrument must be known. For example, the processor 102 is configured to access from a database or other data storage device the TSRF value for a calibration standard 103 obtained by a reference instrument.

Once the coefficient value β has been adjusted so that either the measured TSRF or Whiteness Index values for the calibration standard (103) match the known values obtained from a reference instrument, this coefficient value is then stored for further use. It will be appreciated that coefficient value β is instrument dependent and not sample dependent. Therefore, once the coefficient value β is determined for the test instrument, it can be used to correct the TSRF measurement for any sample under analysis by a calibrated measurement device 100.

Retuning now to step 307 once the calibration process has been conducted, the coefficient value β can be accessed from data or storage 108 and used to adjust the TSRF measurement made by the measurement device. However, as shown in equation 7, more is needed to compensate for the TSRF value than the compensation factor, coefficient value β. Therefore, a measurement correction module 214 further configures a processor 102 of the measurement device 100 to measure a sample 101 to obtain the calibrated TSRF.

As shown in step 314, the processor 102 is configured by the measurement correction module 314 to obtain a TSRF measurement of the sample 101 with only the broadband UV-included illumination light source (such as a xenon light source). This uncalibrated TSRF value is stored as B₂. In one or more arrangements, this TSRF value is obtained from a new or independent measurement of the sample 101. However, in one or more alternative configurations, this B2 value can be accessed from the memory or database 108. For example, the measurement(s) obtained in step 304 are accessed and provided to the processor 102 for further use. Next, the processor 102 is configured by a submodule of the measurement correction module 214 to obtain the fluorescent profile f(λ) of the sample 101 with only the narrow-band UV LED activated. Again, this sub step can take place as an independent measurement step or alternatively, can involve accessing a stored fluorescent profile of the sample previously obtained. Using these two measurements, the B value obtained from the calibration process, and S0(λ) stored in the instrument, the processor 102 is configured by the measurement correction module 214 to provide these values as input to equation 7 and obtain the corrected TSRF value for the sample 101 under analysis. In one arrangement, the S0(λ) value is stored in the instrument because of the calibration process described in step 406. However, in an alternative configuration, the processor 102 is configured by the access module 210 to obtain this value from a data storage device, on-line data repository or receive direct data input from a user of the testing device.

It will be appreciated that one advantage the calibration and measurement modification approach described herein is that, typically, when leaving the factory, a measurement instrument (herein the test instrument) already has a broadband illumination light source with UV content similar to that of a reference instrument. That is, the xenon lamp of a test instrument and xenon lamp of a reference instrument have similar characteristics. Therefore, the adjustment to the uncalibrated TSRF values will be small. It should be further appreciated that the smaller the adjustment is, the more accurate the TSRF result will be. In an ideal situation, if no adjustment is needed, the directly measured TSRF result will match that obtained with a reference instrument. Another advantage of this approach is that it does not matter if the UV content of the broadband light source in the test instrument is larger or smaller than that of a reference instrument, the same calibration approach can be used to adjust the TSRF result of the test instrument to match the standard TSRF result. As such, the lifetime of the test instrument can be increased because the lamp with lower UV content due to aging can still be used in the instrument for extended time without being replaced.

In an alternative configuration, the broadband lamp and the narrow-band lamp are the same as the test instrument discussed above, however, the test sample 101 is not limited to OBA sample. Here, the fluorescent peak can be in a longer wavelength range, such as green, orange, or red. The excitation wavelength is not limited to the UV range, either. On the other hand, the UV LED can still excite fluorescent light in that longer wavelength range.

In fact, as shown in U.S. Pat. No. 10,883,878 granted to Xu et. al., (commonly owned herewith) many different wavelength lights can excite the same fluorescent light in a fluorescent sample. If this is the case, then the same method discussed in the previous implementation to calibrate the test instrument and measure the TSRF of a fluorescent sample to provide the TSRF result that is comparable to that of a reference instrument can be carried out.

The prior art and existing approaches are not able to implement this approach, and as such the described approach represents an improvement in the technical field of color measurement devices, systems, and methods.

In yet another implementation, the broadband light source is still the same as discussed in previous implementations, however, the narrow-band LED can be replaced by multiple narrow-band LEDs with different center wavelengths. In one arrangement, the processor 102 is configured with a multi-LED measurement module 216. This multi-LED measurement module configures each of the LEDs to be turned on individually in order to obtain the fluorescent profile of a measurement sample 102. The multi-LED measurement module 216 configures the processor 102 to store these values for further use.

In one arrangement, the processor is configured by the measurement correction module 214 to obtain the other values described in step 314. However, instead of providing those values to equation 7, those values, including the multi-LED measurement values are provided to the following equation:

$${B}_{1} ( λ ) = {B}_{2} ( λ ) - {β}_{1} {f}_{1} ( λ ) / {S}_{0} ( λ ) - {β}_{2} {f}_{2} ( λ ) / {S}_{0} ( λ ) - … - {β}_{n} {f}_{n} ( λ ) / {S}_{0} ( λ ) \qquad ( 8 )$$

where f1(λ), f2(λ), . . . , fn(λ) are various fluorescent profiles measured with each individual narrow-band LED, β1, β2, . . . , βn are various coefficients determined in the calibration process with each LED. Since we have n number of LEDs to get n number of equations from equation (8), the processor 102 is configured to solve n number of coefficients. Once those coefficients are obtained, the processor 102 is configured to use the test instrument to measure the TSRF of a fluorescent sample and use equation (8) to adjust the result to obtain a standard TSRF result that is comparable to that of a reference instrument.

In yet another implementation, for more complicated cases where β is not just a constant, but a function of wavelength λ, the processor 102 is configured to modify equation (7) such that it becomes:

$${B}_{1} ( λ ) = {B}_{2} ( λ ) - β ( λ ) f ( λ ) / {S}_{0} ( λ ) \qquad ( 9 )$$

In this case, a standard with known TSRF can be used to calibrate the test instrument to obtain β(λ), and after calibration, the measured TSRF of the test instrument can be adjusted using equation (9) to obtain calibrated TSRF.

In yet another implementation, instead of using just a broadband Xenon light source and a narrow-band LED light source, a broadband Xenon light source with UV cutoff filter can also be integrated into the test device. In this implementation, there are three (3) light sources: UV-included broadband light source, UV-excluded broadband light source, narrow-band UV light source. With those different light sources, it is possible to measure, respectively, the spectral radiance factor B_{UVinc}(λ), B_{UVexc}(λ), and fluorescence profile f(λ) of a sample. With those measurement results, a TSRF (call it B1) can be constructed of the same sample measured with a reference instrument:

$${B}_{1} ( λ ) = {c}_{1} {B}_{U V i n c} ( λ ) + {c}_{2} {B}_{U V e x c} ( λ ) + {c}_{3} f ( λ ) / {S}_{0} ( λ ) \qquad ( 10 )$$

where c1, c2 and c3 are system coefficients that can be determined in the calibration process. To calibrate, we need at least three standards with known TSRF or whiteness index, and the process is similar to that described earlier.

In the above-mentioned implementation examples, we mentioned certain types of illumination light sources. However, people can understand that other light sources can be used to serve the same purpose. For example, the broadband light source can be Xenon lamp, tungsten lamp, LED, and other light sources, or a combination of different light sources. Similarly, the narrow-band light source can be LED, filtered light sources, or other types of light sources that can provide excitation light wavelengths to generate fluorescent light from the measurement samples.

Further, in the above-mentioned implementation examples, sometimes we discussed the calibration process to determine β or β(λ) using only one calibration standard. However, a skilled person in the field can easily understand that calibration with more than one standard to obtain multiple sets of β or β(λ), and use weighted average or other combination of those multiple sets of β or β(λ) to obtain the final β or β(λ) may also be performed to achieve a more accurate calibration result.

Further, the foregoing examples and implementations discussed calibration and measurement with reflective samples above. However, a skilled person in the field can understand that the same method can also be applied to calibrate and measure transmissive samples. In those cases, equations (7)˜(10) still stay true (the definition of β can be modified to align with transmission measurement), and the calibration and measurement process are still similar to that in reflective sample cases.

While this specification contains many specific embodiment details, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter have been described in this specification. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems cited throughout this application are incorporated by reference herein. Citation of any above publications or documents is not intended as an admission that any of the foregoing is pertinent prior art, nor does it constitute any admission as to the contents or date of these publications or documents. All references cited herein are incorporated by reference to the same extent as if each individual publication and reference were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those claims, and by equivalents of such features.

What is claimed is:

1. A color measurement system for obtaining the total spectral radiance factor (TSRF) of a sample under analysis, the system comprising:
a color measurement device comprising:
a first illuminator,
a second illuminator, and
a processor configured by code executing therein to
obtain a first measurement of the sample under a first illumination generated by the first illuminator;
obtain a second measurement of the sample under a second illumination generated by the second illuminator;
obtaining a lamp profile of the first illuminator from one of a plurality of data storage devices accessible to the processor;
obtaining a calibration factor, wherein the calibration factor is generated using measurements obtained from at least the first and second illuminator;
calculating a compensated TSRF value for the sample using the first measurement, the second measurement, the lamp profile, and the calibration factor;
outputting the compensated TSRF value for the sample.

2. The system of claim 1, wherein the compensated TSRF value is calculated according to:
$${B}_{1} ( λ ) = {B}_{2} ( λ ) - β f ( λ ) / {S}_{0} ( λ )$$
Where, β₁(λ) is the compensated TSRF value of the calibration standard, B₂(λ) is the first measurement made under the first illuminator, f(λ) is the second measurement made under the second illuminator, S₀(λ) is the lamp profile of the first illuminator and β is the calibration factor.

3. The system of claim 1, wherein the first illuminator is a broad-band light source configured to emit light across substantially all of the visible light wavelengths and at least a portion of the fluorescence excitation wavelengths.

4. The system of claim 1, wherein the second illuminator is a narrow-band light source configured to generate light substantially outside of the fluorescence excitation wavelengths.

5. The system of claim 1, wherein obtaining the calibration factor comprises:
obtaining a first and second measurement of a calibration standard having a known whiteness index with the first and second illuminator;
obtaining a lamp profile of the first illuminator; and
adjusting the measured TSRF value by generating a coefficient value so that the whiteness index calculated from the adjusted TSRF value matches the known whiteness index value of the calibration standard.

6. The system of claim 5, wherein the coefficient value is generated according to:
$${B}_{1} ( λ ) = {B}_{2} ( λ ) - β f ( λ ) / {S}_{0} ( λ )$$
where, B₁(λ) is the adjusted TSRF value of the calibration standard, B₂(λ) is the first measurement made under the first illuminator, f(λ) is the second measurement made under the second illuminator, S₀(λ) is the lamp profile of the first illuminator and β is the calibration factor.

7. The system of claim 6, wherein generating the coefficient value further includes generating a plurality of calibration factors for a plurality of calibration standards and obtaining an average value for the plurality of calibration values and providing the average of the calibration factors as β.

8. The system of claim 1, wherein obtaining the calibration factor comprises:
obtaining a first and second measurement of a calibration standard having a known TSRF with the first and second illuminator;
obtaining a lamp profile of the first illuminator; and
generating a coefficient value using the known TSRF value, the lamp profile, and the first and second measurement;
wherein generating the coefficient value is such that the following equation is true:
$${B}_{1} ( λ ) = {B}_{2} ( λ ) - β f ( λ ) / {S}_{0} ( λ )$$
Where, B₁(λ) is the known TSRF value of the calibration standard, B₂(λ) is the first measurement made under the first illuminator, f(λ) is the second measurement made under the second illuminator, S₀(λ) is the lamp profile of the first illuminator and β is the calibration factor.

9. A color measurement system for obtaining the total spectral radiance factor (TSRF) of a sample under analysis, the system comprising:
a color measurement device comprising:
a first illuminator,
a plurality of narrow-band illuminators, and
a processor configured by code executing therein to
obtain a first measurement of the sample under a first illumination generated by the first illuminator;
obtain a plurality of measurement of the sample under each of plurality of narrow band illuminators;
obtaining a lamp profile of the first illuminator from one of a plurality of data storage devices accessible to the processor;
obtaining a calibration factor for each of the plurality of narrow-band illuminators;
calculating a compensated TSRF value using the first measurement, the second measurement, the lamp profile, and the plurality of calibration factors;
outputting the compensated TSRF value for the sample.

10. The color measurement system of claim 9, wherein the compensated TSRF value is calculated according to:
$${B}_{1} ( λ ) = {B}_{2} ( λ ) - {β}_{1} {f}_{1} ( λ ) / {S}_{0} ( λ ) - {β}_{2} {f}_{2} ( λ ) / {S}_{0} ( λ ) - … - {β}_{n} {f}_{n} ( λ ) / {S}_{0} ( λ )$$
where f1(λ), f2(λ), . . . , fn(λ) are measurements obtained under each of the plurality of narrow-band illuminators, β1, β2, . . . , βn are the calibration factors; S₀(λ) is the lamp profile of the first illuminator and B₁(λ) is the calibrated TSRF.

11. The system of claim 1 wherein the compensated TSRF value is obtained according to:
$${B}_{1} ( λ ) = {B}_{2} ( λ ) - β ( λ ) f ( λ ) / {S}_{0} ( λ )$$
Where, B₁(λ) is the compensated TSRF value of the calibration standard, B₂(λ) is the first measurement made under the first illuminator, f(λ) is the second measurement made under the second illuminator, S₀(λ) is the lamp profile of the first illuminator and β(λ) is the calibration factor.

12. A method of obtaining the total spectral radiance factor (TSRF) of a sample under analysis, the method comprising:
obtaining a first measurement of the sample under a first illumination generated by a first illuminator;
obtaining a second measurement of the sample under a second illumination generated by a second illuminator;
obtaining a lamp profile of the first illuminator;
obtaining a calibration factor, wherein the calibration factor is generated using measurements obtained from at least the first and second illuminator;
calculating a compensated TSRF value using the first measurement, the second measurement, the lamp profile, and the calibration factor; and
outputting the compensated TSRF value for the sample.

13. The method of claim 12, wherein the compensated TSRF value is generated according to:
$${B}_{1} ( λ ) = {B}_{2} ( λ ) - β f ( λ ) / {S}_{0} ( λ )$$
Where, B₁(λ) is the compensated TSRF value of the calibration standard, B₂(λ) is the first measurement made under the first illuminator, f(λ) is the second measurement made under the second illuminator, S₀(λ) is the lamp profile of the first illuminator and β is the calibration factor.

14. The method of claim 12, wherein the first illuminator is a broad-band light source configured to emit light across substantially all of the visible light wavelengths and at least a portion of the fluorescence excitation wavelengths.

15. The method of claim 12, wherein the second illuminator is a narrow-band light source configured to generate light substantially outside of the fluorescence excitation wavelengths.

16. The method of claim 12, wherein obtaining the calibration factor comprises:
obtaining a first and second measurement of a calibration standard having a known whiteness index with the first and second illuminator;
obtaining a lamp profile of the first illuminator; and
adjusting the measured TSRF value by generating a coefficient value so that the whiteness index calculated from the adjusted TSRF value matches the known whiteness index value of the calibration standard.

17. The method of claim 12, wherein generating the coefficient value is such that the following equation is true:
$${B}_{1} ( λ ) = {B}_{2} ( λ ) - β f ( λ ) / {S}_{0} ( λ )$$
Where, B₁(λ) is the known TSRF value of the calibration standard, B₂(λ) is the first measurement made under the first illuminator, f(λ) is the second measurement made under the second illuminator, S₀(λ) is the lamp profile of the first illuminator and β is the calibration factor.
